(19) United States
(12) Patent Application Publication
(10) Pub. No.: US 2021/0194236 A1
(43) Pub. Date: Jun. 24, 2021

(54) POWER CIRCUIT

(71) Applicant: TCL China Star Optoelectronics Technology Co., Ltd., Shenzhen (CN)

(72) Inventors: Jilong Li, Shenzhen (CN); Yue Wang, Shenzhen (CN)

(73) Assignee: TCL CHINA STAR OPTOELECTRONICS TECHNOLOGY CO., LTD., Shenzhen (CN)

(21) Appl. No.: 16/646,024

(22) PCT Filed: Feb. 25, 2020
(86) PCT No.: PCT/CN2020/076561

§ 371 Date: Mar. 10, 2020

(30) Foreign Application Priority Data
Dec. 23, 2019 (CN) 201911340194.9

(51) Int. Cl. H02H 1/06; G09G 3/20

(52) U.S. Cl. CPC H02H 1/06; G09G 2330/021; G09G 3/20

(57) ABSTRACT

A power circuit includes a bleeder circuit, wherein a first terminal of the bleeder circuit is an output terminal, and a second terminal of the bleeder circuit is grounded; a control circuit, wherein a first terminal of the control circuit is connected to the output terminal, a second terminal of the control circuit is a feedback terminal and is connected to the bleeder circuit, and a third terminal of the control circuit is an input terminal; and a feedback capacitor, wherein a first terminal of the feedback capacitor is connected to the output terminal, and a second terminal of the feedback capacitor is connected to the bleeder circuit. The power circuit adds a feedback capacitor between the output terminal and the feedback terminal and can rapidly provide output terminal voltage changes to the feedback terminal and accelerate regulation of an output voltage.

### FIELD OF INVENTION

The present invention relates to the field of display technology, and especially to a power circuit.

### BACKGROUND OF INVENTION

In practical operation, panels usually have switch between light and heavy loads, which causes unstable output voltages. When affected by exterior conditions, output voltages vary and conventional power circuits cannot rapidly feedback output terminal voltage changes to a feedback terminal. Because resolution and refresh rates of current panels become higher and higher and response speed of conventional designs of power circuits is slow, pictures displayed will be affected when voltages are pulled down.

### SUMMARY OF INVENTION

The present invention provides a power circuit to resolve the technical problem that response speed of conventional power circuits is slow, and pictures displayed will be affected when voltages are pulled down.

In order to resolve the above-mentioned problem, the present invention provides the following technical approach.

The present invention provides a power circuit that includes a bleeder circuit, wherein a first terminal of the bleeder circuit is an output terminal and is configured to receive an output signal, and a second terminal of the bleeder circuit is grounded; a control circuit, wherein a first terminal of the control circuit is connected to the output terminal and is configured to output the output signal, a second terminal of the control circuit is a feedback terminal and is connected to the bleeder circuit to receive a feedback signal, and a third terminal of the control circuit is an input terminal and is configured to receive an input signal; and a feedback capacitor, wherein a first terminal of the feedback capacitor is connected to the output terminal, and a second terminal of the feedback capacitor is connected to the bleeder circuit and is configured to feedback the output signal.

According to at least one embodiment of the present invention, the bleeder circuit includes a first resistor and a second resistor, a first terminal of the first resistor is connected to the output terminal, and a second terminal of the first resistor is connected to a first terminal of the second resistor, wherein the second terminal of the feedback capacitor is connected to the second terminal of the first resistor.

According to at least one embodiment of the present invention, the second terminal of the control circuit is connected to the second terminal of the first resistor.

According to at least one embodiment of the present invention, the bleeder circuit further includes a third resistor, the first terminal of the second resistor is connected to the second terminal of the feedback capacitor, a second terminal of the second resistor is connected to a first terminal of the third resistor, and a second terminal of the third resistor is grounded.

According to at least one embodiment of the present invention, the power circuit further includes a regulator circuit, wherein the regulator circuit comprises a fourth resistor and a first capacitor, a first terminal of the fourth resistor is connected to the input terminal, and a second terminal of the fourth resistor is grounded, wherein the first capacitor is in parallel with the fourth resistor.

According to at least one embodiment of the present invention, the regulator circuit further includes a second capacitor in parallel with the fourth resistor.

According to at least one embodiment of the present invention, the regulator circuit further includes a third capacitor in parallel with the fourth resistor.

According to at least one embodiment of the present invention, the regulator circuit further includes a fourth capacitor in parallel with the fourth resistor.

According to at least one embodiment of the present invention, the control circuit includes a pulse width modulator.

A power circuit according to the present invention adds a feedback capacitor between an output terminal and a feedback terminal. Capacitors have a property that voltages of their two terminals cannot instantly become different from the other, that is, when a voltage of one terminal varies, the other terminal will instantly vary, and this property can be used to rapidly provide output terminal voltage changes to a feedback terminal and accelerate regulation of output voltage. In addition to conveniently and quickly increasing transient response speed of panel integrated circuits (ICs), the present invention also has an effect of compensating output bandwidth, and when capacitance of the feedback capacitor is greater, the bandwidth is wider.

### DESCRIPTION OF DRAWINGS

In order to further understand features and technical contents of the present invention, please refer to the following detailed description and accompanying drawings of the present invention. However, the accompanying drawings are used for purpose of explanation and do not limit the present invention.

With reference to the following drawings, the technical approach and other beneficial effects of the present invention will be obvious through describing embodiments of the present invention in detail.

The drawings are as the following.

FIG. 1 is a circuit diagram of a power circuit according to an embodiment of the present invention.

### DETAILED DESCRIPTION OF PREFERRED EMBODIMENTS

In order to further describe the technical approach and the effects of the present invention, the following describes in detail with reference to advantageous embodiments and the accompanying drawings of the present invention.

Because resolution and refresh rates of current panels become higher and higher and response speed of conventional designs of power circuits is slow, pictures displayed will be affected when voltages are pulled down. The present invention can resolve this technical problem.

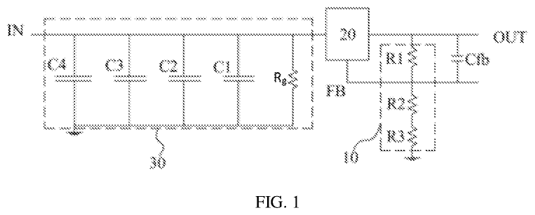

FIG. 1 is a circuit diagram of a power circuit according to an embodiment of the present invention. The power circuit includes a bleeder circuit 10, wherein a first terminal of the bleeder circuit 10 is an output terminal OUT and is configured to receive an output signal, and a second terminal of the bleeder circuit 10 is grounded; a control circuit 20, wherein a first terminal of the control circuit 20 is connected to the output terminal OUT and is configured to output the output signal, a second terminal of the control circuit 20 is a feedback terminal FB and is connected to the bleeder circuit 10 to receive a feedback signal, and a third terminal of the control circuit 20 is an input terminal IN and is configured to receive an input signal; and a feedback capacitor Cfb, wherein a first terminal of the feedback capacitor Cfb is connected to the output terminal OUT, and a second terminal of the feedback capacitor Cfb is connected to the bleeder circuit 10 and is configured to feedback the output signal.

The bleeder circuit 10 includes a first resistor R1 and a second resistor R2, a first terminal of the first resistor R1 is connected to the output terminal OUT, and a second terminal of the first resistor R1 is connected to a first terminal of the second resistor R2, wherein the second terminal of the feedback capacitor Cfb is connected to the second terminal of the first resistor R1. The second terminal of the control circuit 20 is connected to the second terminal of the first resistor R1.

The control circuit 20 transforms a signal of the input terminal IN into an output voltage of the output terminal OUT according to a signal of the feedback terminal FB. The control circuit 20 includes, for example, a pulse width modulator, regulates a duty cycle, and calibrates an output voltage according to voltage variation conditions of the feedback terminal FB.

As shown in FIG. 1, the present invention divides an output voltage by using resistors and feedbacks a divided result voltage to the control circuit 20 through the feedback terminal FB to regulate and calibrate voltage. Furthermore, the present invention adds a feedback capacitor Cfb between an output terminal OUT and a feedback terminal FB. Capacitors have a property that voltages of their two terminals cannot instantly become different from the other, that is, when a voltage of one terminal varies, the other terminal will vary instantly, and this property can be used to rapidly provide output terminal OUT voltage changes to the feedback terminal FB and accelerate regulation of an output voltage. In addition to conveniently and quickly increasing transient response speed of the control circuit 20, the present invention also has an effect of compensating output bandwidth, and when capacitance of the feedback capacitor Cfb is greater, the bandwidth is wider.

The bleeder circuit 10 further includes a third resistor R3, the first terminal of the second resistor R2 is connected to the second terminal of the feedback capacitor Cfb, a second terminal of the second resistor R2 is connected to a first terminal of the third resistor R3, and a second terminal of the third resistor R3 is grounded.

The bleeder circuit 10 according to the present embodiment includes three resistors. In other embodiments, it can also include one, two, or multiple resistors, and the present invention does not limit the number of resistors of the bleeder circuit 10.

The power circuit further includes a regulator circuit 30, wherein the regulator circuit includes a fourth resistor R4 and a first capacitor C1, a first terminal of the fourth resistor R4 is connected to the input terminal IN, and a second terminal of the fourth resistor R4 is grounded, wherein the first capacitor C1 is in parallel with the fourth resistor R4.

The regulator circuit further includes a second capacitor C2 in parallel with the fourth resistor R4. The regulator circuit further includes a third capacitor C3 in parallel with the fourth resistor R4. The regulator circuit further includes a fourth capacitor C4 in parallel with the fourth resistor R4. The panel is a liquid crystal panel or panels of other forms.

The regulator circuit according to the present embodiment includes four capacitors. In other embodiments, it can also include other numbers of capacitors, and the present invention does not limit the number of capacitors.

Beneficial effects: a power circuit according to the present invention adds a feedback capacitor between an output terminal and a feedback terminal. Capacitors have a property that voltages of their two terminals cannot instantly become different from the other, that is, when a voltage of one terminal varies, the other terminal will instantly vary, and this property can be used to rapidly provide output terminal voltage changes to a feedback terminal and accelerate regulation of an output voltage. In addition to conveniently and quickly increasing transient response speed of panel integrated circuits (ICs), the present invention also has an effect of compensating output bandwidth, and when capacitance of the feedback capacitor is greater, the bandwidth is wider.

Although the present invention has been explained in relation to its preferred embodiment, it does not intend to limit the present invention. It is obvious to those skilled in the art having regard to this present invention that other modifications of the exemplary embodiments beyond these embodiments specifically described here may be made without departing from the spirit of the invention. Accordingly, such modifications are considered within the scope of the invention as limited solely by the appended claims.

1. A power circuit, comprising:
a bleeder circuit, wherein a first terminal of the bleeder circuit is an output terminal and is configured to receive an output signal, and a second terminal of the bleeder circuit is grounded;
a control circuit, wherein a first terminal of the control circuit is connected to the output terminal and is configured to output the output signal, a second terminal of the control circuit is a feedback terminal and is connected to the bleeder circuit to receive a feedback signal, and a third terminal of the control circuit is an input terminal and is configured to receive an input signal;
a feedback capacitor, wherein a first terminal of the feedback capacitor is connected to the output terminal, and a second terminal of the feedback capacitor is connected to the bleeder circuit and is configured to feedback the output signal; and
a regulator circuit, wherein the regulator circuit comprises a regulating resistor and a first capacitor, a first terminal of the regulating resistor is directly connected to the input terminal, and a second terminal of the regulating resistor is directly grounded, wherein the first capacitor is in parallel with the regulating resistor.

2. (canceled)

3. (canceled)

4. The power circuit as claimed in claim 1, wherein the bleeder circuit comprises a first resistor and a second resistor, a first terminal of the first resistor is connected to the output terminal, and a second terminal of the first resistor is connected to a first terminal of the second resistor, wherein the second terminal of the control circuit is connected to the second terminal of the first resistor.

5. The power circuit as claimed in claim 4, wherein the bleeder circuit comprises a third resistor, the first terminal of the second resistor is connected to the second terminal of the feedback capacitor, a second terminal of the second resistor is connected to a first terminal of the third resistor, and a second terminal of the third resistor is grounded.

6. (canceled)

7. The power circuit as claimed in claim 1, wherein the regulator circuit further comprises a second capacitor in parallel with the regulating resistor.

8. The power circuit as claimed in claim 7, wherein the regulator circuit further comprises a third capacitor in parallel with the regulating resistor.

9. The power circuit as claimed in claim 8, wherein the regulator circuit further comprises a fourth capacitor in parallel with the regulating resistor.

10. The power circuit as claimed in claim 1, wherein the control circuit comprises a pulse width modulator.

11. A power circuit, comprising:
a bleeder circuit, wherein a first terminal of the bleeder circuit is an output terminal and is configured to receive an output signal, and a second terminal of the bleeder circuit is grounded;
a control circuit, wherein a first terminal of the control circuit is connected to the output terminal and is configured to output the output signal, a second terminal of the control circuit is a feedback terminal and is connected to the bleeder circuit to receive a feedback signal, and a third terminal of the control circuit is an input terminal and is configured to receive an input signal;
a feedback capacitor, wherein a first terminal of the feedback capacitor is connected to the output terminal, and a second terminal of the feedback capacitor is connected to the bleeder circuit and is configured to feedback the output signal; and
a regulator circuit, wherein the regulator circuit comprises a regulating resistor and a first capacitor, a first terminal of the regulating resistor is directly connected to the input terminal, and a second terminal of the regulating resistor is directly grounded, wherein the first capacitor is in parallel with the regulating resistor;
wherein the bleeder circuit comprises a first resistor and a second resistor, a first terminal of the first resistor is connected to the output terminal, and a second terminal of the first resistor is connected to a first terminal of the second resistor, wherein the second terminal of the feedback capacitor is connected to the second terminal of the first resistor.

12. The power circuit as claimed in claim 11, wherein the second terminal of the control circuit is connected to the second terminal of the first resistor.

13. The power circuit as claimed in claim 11, wherein the bleeder circuit comprises a third resistor, the first terminal of the second resistor is connected to the second terminal of the feedback capacitor, a second terminal of the second resistor is connected to a first terminal of the third resistor, and a second terminal of the third resistor is grounded.

14. (canceled)

15. The power circuit as claimed in claim 11, wherein the regulator circuit further comprises a second capacitor in parallel with the regulating resistor.

16. The power circuit as claimed in claim 15, wherein the regulator circuit further comprises a third capacitor in parallel with the regulating resistor.

17. The power circuit as claimed in claim 16 wherein the regulator circuit further comprises a fourth capacitor in parallel with the regulating resistor.

18. The power circuit as claimed in claim 11, wherein the control circuit comprises a pulse width modulator.
